(19) United States
(12) Patent Application Publication
(10) Pub. No.: US 2009/0205632 A1
(43) Pub. Date: Aug. 20, 2009

(54) Stove system using combustion gas

(76) Inventor: Kao Hsung Tsung, Taipei City (TW)

Correspondence Address: BACON & THOMAS, PLLC, 625 SLATERS LANE, FOURTH FLOOR, ALEXANDRIA, VA, 22314-1176, US

(21) Appl. No.: 12/071,306

(22) Filed: Feb. 20, 2008

(51) Int. Cl. F24C 3/00; G01L 7/00

(52) U.S. Cl. 126/39 R; 73/700

(57) ABSTRACT

A stove system that can show amount of gas stored, the system is provided with a pressure reducer between an gas intake pipe and a gas delivering pipe of a stove, and has an indicator installed on the housing of the stove for displaying the amount of gas stored, the indicator is connected to the gas delivering pipe via a bypass pipe in order that combustion gas can be supplied for the stove through the gas delivering pipe, the pressure reducer and the gas intake pipe for combustion, and is connected to the indicator via the bypass pipe for displaying the amount of gas stored, a user thus can easily read the amount of gas stored through the indicator on the housing of the stove, this can avoid fire stopping in the middle of cooking.

### BACKGROUND OF THE INVENTION

1. Field of the Invention

The present invention relates to a stove system using combustion gas, and especially to a stove that can show amount of gas stored.

2. Description of the Prior Art

Nearly all people cooking usually have the following unpleased experience, that is, during cooking, namely in the middle or in the beginning of cooking, combustion gas stored in a steel container (gas container) is exhausted, a user must wait for a supplier (gas dealer) to change the gas container at this time, and a normal meal time will be delayed.

In order to avoid such unpleased matter, a pressure gauge is provided at a gas outlet valve of a gas container in a conventional technique, a user can use the pressure gauge to read the amount of gas stored in the gas container, for the purpose of changing the gas container before exhausting of gas.

However, the above mentioned pressure gauge is installed at the gas outlet valve of the gas container, while for the sake of safety and good appearance, the gas container generally is put at a hidden corner of a kitchen; some kitchens being specially designed and decorated have the gas containers placed in a specific cabinet.

In other words, even when the gas container is installed with the pressure gauge for reading, reading of information on the pressure gauge is still very cumbersome and is unable to get the expected effect.

### SUMMARY OF THE INVENTION

The technical problem to be solved in the present invention is to provide a stove system that can read the amount of gas stored.

The technical way that the present invention uses to solve the above technical problem is to provide a pressure reducer between a gas intake pipe and a gas delivering pipe of the stove, and to install an indicator on the housing of the stove for displaying the amount of gas stored, the indicator is connected to the gas delivering pipe via a bypass pipe in order that combustion gas can be supplied for the stove system through the gas delivering pipe, the pressure reducer and the gas intake pipe, and is connected to the indicator via the bypass pipe for displaying the amount of gas stored, a user thus can easily read the amount of gas stored through the indicator on the housing of the stove, this can avoid fire stopping in the middle of cooking.

In practicing, the bypass pipe between the indicator and the gas delivering pipe can be provided with a bypass port on a connector for connecting the gas delivering pipe and the pressure reducer; by connecting of the bypass port to the gas intake end of the bypass pipe, the combustion gas can be connected via the gas delivering pipe, the bypass port and the bypass pipe to the indicator before entering the pressure reducer, so that the indicator can correctly display the amount of gas stored.

In practicing, the bypass pipe between the indicator and the gas delivering pipe can be a high pressure durable metal pipe. Except to this, the bypass port on the connector and the gas intake end of the bypass pipe can be connected with each other by the mode of screw connecting; this can have the advantage of convenience for installing and assembling.

And more, for the purpose of convenience for reading information, the indicator can be a normal pressure gauge installed on a control panel of the stove; this makes better appearance in addition to increasing the convenience of changing parts and applicability of the parts.

In comparison with the prior art now available, the indicator indicating the amount of gas stored of the present invention is installed on the housing of the stove, the user can read the amount of gas stored very conveniently, and can arrange his work of cooking according to the information displayed on the indicator to avoid fire stopping in the middle or in the beginning of cooking.

The present invention will be apparent after reading the detailed description of the preferred embodiment thereof in reference to the accompanying drawings.

### BRIEF DESCRIPTION OF THE DRAWINGS

FIG. 1 is a perspective view showing a lateral side of the present invention;

FIG. 2 is a perspective view showing the front side of the present invention;

FIG. 3 is a perspective schematic view showing the present invention is connected with a gas steel container;

FIG. 4 is a partially enlarged perspective schematic view taken from FIG. 3.

### DETAILED DESCRIPTION OF THE PREFERRED EMBODIMENT

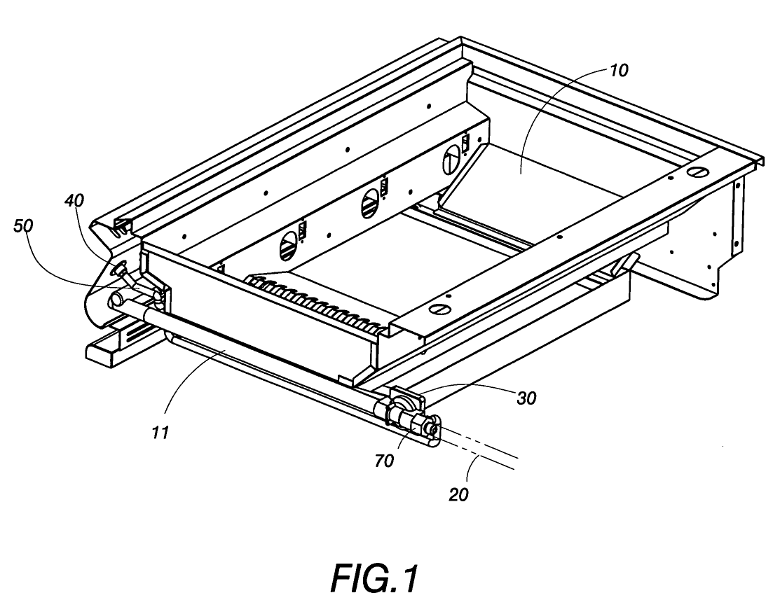

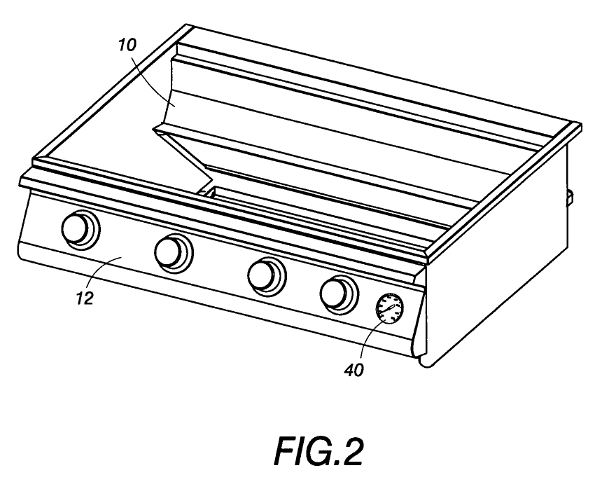

As shown in FIGS. 1 and 2, we can see that the stove system of the present invention can display amount of gas stored; wherein a stove 10 has a reducer 30 provided between its gas intake pipe 11 and its gas delivering pipe 20, and has a control panel 12 and an indicator 40 on the housing of the stove 10, the indicator 40 is connected to the gas delivering pipe 20 via a bypass pipe 50, in order that combustion gas can be supplied for the stove 10 through the gas delivering pipe 20, the pressure reducer 30 and the gas intake pipe 11, and is connected to the indicator 40 via the bypass pipe 50 for displaying the amount of gas stored, a user thus can easily read the amount of gas stored through the indicator 40 on the control panel 12 of the stove 10 housing of the stove, this can avoid fire stopping in the middle of cooking.

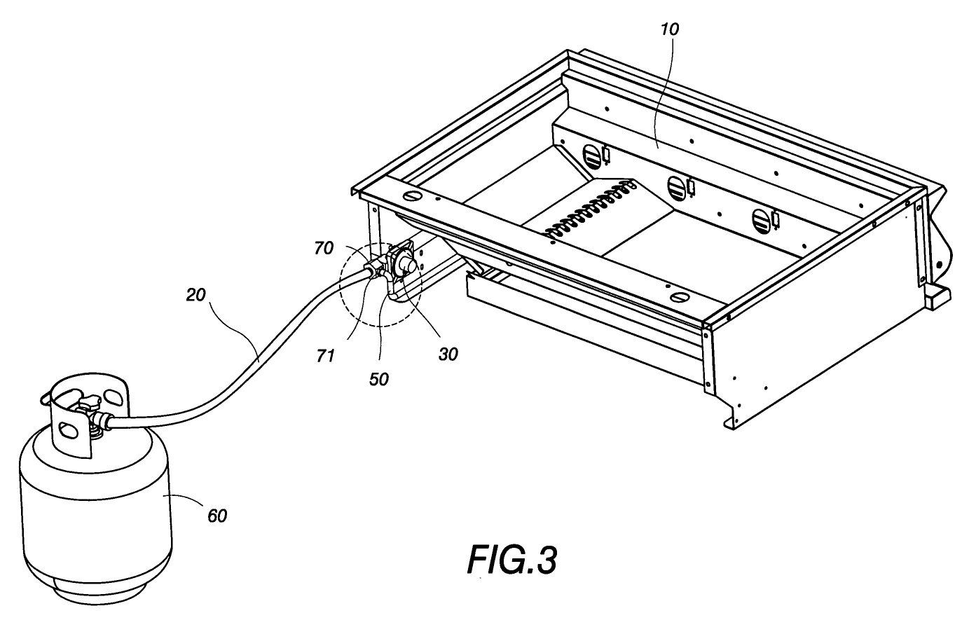

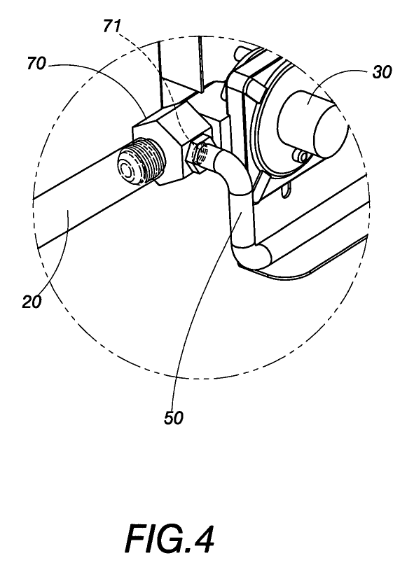

As shown in FIGS. 2, 3 and 4, the combustion gas is stored in a steel container 60 (called as gas container), one end of the gas delivering pipe 20 is connected with the gas steel container 60, while the other end is connected with the pressure reducer 30 via a connector 70. In practicing, a bypass pipe 50 is provided between the indicator 40 and the gas delivering pipe 20. And in practicing, the bypass pipe 50 connected between the indicator 40 and the gas delivering pipe 20 can be provided with a bypass port 71 on the connector 70, by connecting of the bypass port 71 to the gas intake end of the bypass pipe 50, the combustion gas can be connected via the gas delivering pipe 20, the bypass port 70 and the bypass pipe 50 to the indicator 40 before entering the pressure reducer 30, so that the indicator 40 can correctly display the amount of gas stored.

In practicing, the bypass pipe 50 connected between the indicator 40 and the gas delivering pipe 20 can be of a high pressure durable metal pipe. Except to this, the bypass port 71 on the connector 70 and the gas intake end of the bypass pipe 50 can be connected with each other by the mode of screw connecting; this can have the advantage of convenience for installing and assembling.

As shown in FIG. 2, for the convenience of reading information, the indicator 40 can be a normal pressure gauge installed on the control panel 12 of the stove 10; this makes better appearance in addition to increasing the convenience of changing parts and applicability of the parts.

The names of the members for the present invention are only for illustrating preferred embodiments of the present invention, and not for giving any limitation to the scope of the present invention. It will be apparent to those skilled in this art that various equivalent modifications or changes without departing from the spirit, scope and characteristic of this invention shall fall within the scope of the appended claims and are intended to form part of this invention.

1. A stove system adapted for showing amount of gas stored, said stove system has a reducer provided between a gas intake pipe and a gas delivering pipe thereof, and has an indicator on a housing of a stove, said indicator is connected to said gas delivering pipe via a bypass pipe, in order that combustion gas is supplied for said stove through said gas delivering pipe, said pressure reducer and said gas intake pipe for combustion, and is connected to said indicator via said bypass pipe for displaying amount of gas stored, a user thus easily reads said amount of gas stored through said indicator on said housing of said stove, this avoids fire stopping in middle of cooking.

2. The stove system adapted for showing amount of gas stored as in claim 1, wherein said combustion gas is stored in a steel container, one end of said gas delivering pipe is connected with said gas steel container, while other end is connected with said pressure reducer via a connector.

3. The stove system adapted for showing amount of gas stored as in claim 2, wherein said connector is provided with a bypass port connecting to a gas intake end of said bypass pipe, said combustion gas is connected via said gas delivering pipe, said bypass port and said bypass pipe to said indicator before entering said pressure reducer.

4. The stove system adapted for showing amount of gas stored as in claim 3, wherein said bypass port on said connector and said gas intake end of said bypass pipe are connected with each other by a mode of screw connecting.

5. The stove system adapted for showing amount of gas stored as in claim 1, wherein said bypass pipe is a high pressure durable metal pipe.

6. The stove system adapted for showing amount of gas stored as in claim 1, wherein said indicator is a pressure gauge.

7. The stove system adapted for showing amount of gas stored as in claim 1, wherein said pressure gauge is installed on a control panel of said stove.
